(19) United States
(12) Patent Application Publication
(10) Pub. No.: US 2012/0286608 A1
(43) Pub. Date: Nov. 15, 2012

(54) ROLLING BEARING FOR INVERTER-DRIVEN MOTOR AND INVERTER-DRIVEN MOTOR THEREWITH

(75) Inventors: Hiroshi KOMIYAMA, Kitasaku-gun (JP); Shinichi MACHIDA, Kitasaku-gun (JP); Tatsuo MAETANI, Hyogo (JP); Yoshinori ISOMURA, Osaka (JP)

(73) Assignees: PANASONIC CORPORATION, Osaka (JP); MINEBEA CO., LTD., Kitasaku-gun (JP)

(21) Appl. No.: 13/466,387

(22) Filed: May 8, 2012

(30) Foreign Application Priority Data
May 10, 2011 (JP) 2011-105203

(51) Int. Cl. H02K 7/08; F16C 19/02; F16C 33/58; F16C 19/00

(52) U.S. Cl. 310/90; 384/462; 384/513

(57) ABSTRACT

A rolling bearing for an inverter-driven motor has the thickness of an oil film in a steady operation condition stably maintained in a specific range, by which the withstand voltage can be controlled, and the discharge due to the shaft voltage of the inverter-driven motor is prevented and electrolytic corrosion can be suppressed. The rolling bearing for an inverter-driven motor has an inner ring, an outer ring, a rolling element, and grease, wherein a root mean square roughness of a raceway surface of at least one of the inner ring and the outer ring is 4 to 16 nm, and an oil film parameter Λ in steady operation is at least 17.5.

### BACKGROUND OF THE INVENTION

1. Field of the Invention

The present invention relates to a rolling bearing for inverter-driven motors, such as an air conditioner motor, which suppresses generation of electrolytic corrosion, and relates to an inverter-driven motor using the rolling bearing.

2. Description of Related Art

Recently, motors using pulse width modulation (hereinafter, referred to as a PWM), in which the motor is driven by an inverter, have increased. In such a PWM inverter driving method, since a neutral point potential of winding does not become zero, a potential difference (hereinafter, referred to as a shaft voltage) is often, generated between an outer ring and an inner ring of the rolling bearing which supports the shaft. This shaft voltage contains a high frequency component caused by switching, and when the shalt voltage reaches the dielectric breakdown voltage of the oil film in the bearing, small current flows at the inside of the bearing, and electric discharge is generated between the inner and outer rings and the rolling element of the bearing. As a result, local melting of material inside the bearing, so-called electrolytic corrosion, is generated. In the case in which this electrolytic corrosion progresses, a corrugation phenomenon occurs at the surface of the bearing inner ring, the bearing outer ring and the rolling element, so that poor lubrication or abnormal noises occur, and this is one of the primary factors of the problems in the motor.

As a method for suppressing the electrolytic corrosion in the rolling bearing, a technique in which withstand voltage is increased by strengthening insulation between the inner ring and the outer ring of the rolling bearing as much as possible, and a technique in which electric discharge is frequently repeated by making easier to flow electricity between the inner ring and the outer ring of the rolling bearing, so as to not accumulate electric charge between the inner ring and the outer ring of the rolling bearing, are known.

As a method for increasing the withstand voltage by strengthening the insulation, a technique in which the rolling elements retained between the inner ring and the outer ring are formed by press-sintering material having silicon nitride as a primary component, and the roughness of rolling surface thereof is set to be 0.2 Z or less, and therefore, discharge is not generated, even if relatively large voltage is applied between the inner ring and the outer ring, is disclosed in Japanese Unexamined Patent Application Publication No. H7-12129.

However, in this technique of increasing the withstand voltage by strengthening the insulation, although the electrolytic corrosion is avoided thanks to the perfect insulation obtained by the use of rolling elements made by silicon nitride, a bearing using the rolling elements made of silicon nitride becomes very expensive, and producing a motor with such bearing involves a problem of cost.

In addition, as a technique which does not accumulate the electric charge between the inner ring and the outer ring of the rolling bearing, a technique in which generation of the electrolytic corrosion is prevented by short-circuiting the inner ring and the outer ring using a discharge brush, whereby a discharge route excluding the rolling contact portion between the rolling element and the inner and outer rings is ensured, and a technique in which electric conduction frequency on the contact surfaces is increased and potential difference between the inner and outer rings is maintained to be low, and therefore, electrolytic corrosion damage is suppressed, by setting the center line average surface roughness of at least the contact surface of the rolling element to be 50 to 200 nm Ra, are disclosed respectively in Japanese Unexamined Patent Application Publications No. 2007-146966 and No. 2010-74873.

However, in the technique which provides the discharge brush, there is a problem in that, when conductivity of discharge brush is decreased by abrasion, electric resistance of the discharge brush increases becoming higher than that between the inner and outer rings and the rolling element, and electric conduction between the inner and outer rings is resumed. Another problem is that abrasion powder produced from the discharge brush may cause damage at inside of the bearing. In addition, in the technique in which electric discharge is made easier by roughening the contact surface of the inner and outer rings and the rolling element, small discharge is frequently repeated, so that large damage is not generated on the raceway surface. However, there is a problem in that although the discharges are small, roughness of the contact surface is increased and ultimately, service life of the bearing is shortened.

### SUMMARY OF THE INVENTION

The present invention was completed by considering the above problems, and objects thereof are to provide a rolling bearing for an inverter-driven motor in which the oil film thickness in a steady operation condition is stably maintained in a specific range, the withstand voltage can be controlled, and whereby, the discharge due to the shaft voltage of the inverter-driven motor is prevented and electrolytic corrosion can be suppressed.

A rolling bearing for an inverter-driven motor of the present invention includes an inner ring, an outer ring, rolling elements, and grease, in which a root mean square roughness on the raceway surface of at least one of the inner ring and the outer ring is in the range of 4 to 16 nm, and an oil film parameter Λ in a steady operation condition is at least 17.5. Another aspect of the rolling bearing for an inverter-driven motor of the present invention is that it includes an inner ring, an outer ring, rolling elements, and grease, in which a root mean square roughness on the raceway surface of at least one of the inner ring and the outer ring is in the range of 4 to 16 nm, and when the root mean square roughness of the raceway surface is set to be x in units of nm and kinematic viscosity at 40° C. of base oil of the grease is set to be y in units of mm²/s, the equation y≧(3x+12) is satisfied.

In addition, in the rolling bearing for the inverter-driven motor of the present invention, it is preferable that kinematic viscosity at 40° C. of the base oil of the grease be at least 24 mm² is. Furthermore, in the rolling bearing for the inverter-driven motor of the present invention, it is preferable that withstand voltage at 1000 rpm be at least 3 V. Additionally, in the present invention, it is preferable that in the rolling bearing for the inverter-driven motor of the present invention, it is preferable that kinematic viscosity at 40° C. of base oil of the grease be at least 60 mm²/s.

According to the rolling bearing for the inverter-driven motor of the present invention, by setting the root mean square roughness of the raceway surface where the rolling elements roll to be in the range of 4 to 16 nm, and by setting the oil film parameter Λ in a steady operation condition to be at least 17.5, the formation condition of the oil film can be suitably controlled, and thereby discharge at a voltage lower than a specific voltage can be prevented and electrolytic corrosion can be prevented.

Quality of lubricated condition of rolling contact surfaces is evaluated by the oil film parameter Λ, which is the ratio of the thickness of an oil film formed between the contact surfaces and surface roughness of each contact surface. This oil film parameter Λ is expressed by the following equation.

Λ=hmin/σ (Equation 1)

In the above equation, hmin is EHL oil film thickness, σ is composite surface roughness √(σ1²+σ2²) (that is, the square root of (σ1²+σ2²)), and σ1 and σ2 are surface roughness (root mean square roughness) of the rolling element and the rolling groove which are in contact.

It should be noted that since the rolling bearing of the present invention uses grease lubrication, the oil film parameter is calculated using hmin measured from the grease by optical interferometry. In addition, as a conventional value of oil film parameter Λ, for example, a range of 0.8 to 3.0 is disclosed in paragraph [0006] of Japanese Unexamined Patent Application Publication No. 2000-179559 for a case of the rolling bearing under a usual bearing operational condition. This value is completely different from the numerical range of the oil film parameter Λ in the present invention.

Additionally, the inverter-driven motor of the present invention is characterized in that the motor shaft is supported by the above rolling bearing for the inverter-driven motor. According to the inverter-driven motor having such a construction, electrolytic corrosion can be suitably suppressed by applying the above rolling bearing for the inverter-driven motor to an inverter-driven motor which the shaft voltage is lower than the withstand voltage controlled in the above rolling bearing for the inverter-driven motor.

Furthermore, in the rolling bearing for the inverter-driven motor of the present invention, since the electrolytic corrosion is suppressed by controlling the range of base oil kinematic viscosity of grease, mechanical loss does not increase, and long service life is also achieved. Therefore, an inverter-driven motor in which a bearing can be smoothly and continuously rotated for long period can also be easily provided at low cost.

According to the rolling bearing for the inverter-driven motor of the present invention, the oil film thickness in a steady operation condition is stably maintained in a specific range, the withstand voltage can be controlled, and thereby, the discharge due to the shaft voltage of the inverter-driven motor is prevented and electrolytic corrosion can be suppressed.

### BRIEF DESCRIPTION OF THE DRAWINGS

FIG. 1 is a cross-sectional view showing one embodiment of a rolling bearing for inverter-driven motor according to the present invention.

FIG. 2 is a graph showing correlations of the withstand voltage and the root mean square roughness of the raceway surface in relation to the oil film parameter in the present invention.

FIG. 3 is a schematic view showing a withstand voltage measuring apparatus and an electrolytic corrosion reproduction tester with respect to the inverter-driven motor according to the present invention.

FIG. 4 is a schematic cross-sectional view showing an inner rotor type motor which is an embodiment of the inverter-driven motor according to the present invention.

FIG. 5 is a schematic view showing a main section of the inverter-driven motor according to the present invention.

FIG. 6 is a schematic view showing a specific example of a rotor of the inverter-driven motor according to the present invention.

FIG. 7 is a schematic view showing another specific example of a rotor of the inverter-driven motor according to the present invention.

FIG. 8 is a schematic cross-sectional view showing an outer rotor type motor which is an embodiment of the inverter-driven motor according to the present invention,

FIG. 9 is a graph showing voltage value and current value in measuring withstand voltage in the rolling bearing for the inverter-driven motor of the present invention.

FIG. 10 is a graph showing a result of the electrolytic corrosion reproduction test for the rolling bearing for the inverter-driven motor of the present invention.

FIG. 11 is a graph showing a measured result of shaft voltage in the inverter-driven motor of the present invention.

### DESCRIPTION OF PREFERRED EMBODIMENTS

Next, an embodiment of a rolling bearing for inverter-driven motor according to the present invention will be specifically explained.

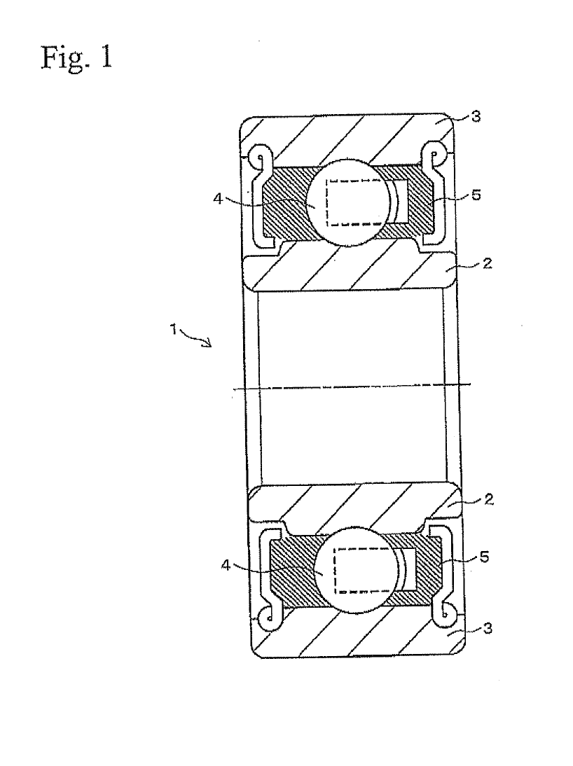

FIG. 1 is a cross-sectional view showing one embodiment of a rolling bearing for inverter-driven motor according to the present invention. As shown in FIG. 1, the rolling bearing for inverter-driven motor 1 of the present invention is a deep groove ball bearing including an inner ring 2 and an outer ring 3 arranged to face each other so as to be relatively rotatable, and a rolling element 4 displaced between the inner ring 2 and the outer ring 3 with grease 5 so as to be rollable, and has a configuration for supporting a motor shaft of the inverter-driven motor.

In the metallic rolling bearing 1 used for the inverter-driven motor, since all of the inner ring 2, the outer ring 3, and the rolling elements 4 are made of metal, electric current flows between these components and damage due to electrolytic corrosion is generated. In order to solve this problem, in the present invention, the oil film thicknesses between the inner ring 2 and the rolling element 4, and between the outer ring 3 and the rolling element 4, when the bearing 1 steadily rotates, can be increased by controlling the root mean square roughness on the raceway surface of at least one of the inner ring 2 and the outer ring 3, and the oil film parameter Λ in a steady operation condition. As a result, the current becomes difficult to flow and electrolytic corrosion is suppressed.

In the rolling bearing for an inverter-driven motor of the present invention, it is necessary that the root mean square roughness on an raceway surface of at least one of an inner ring and an outer ring be in the range of 4 to 16 nm. The formation condition of the oil film can be controlled even when the root mean square roughness on the raceway surface of at least one of the inner ring 2 and the outer ring 3 is less than 4 nm, however, rather extreme accuracy is required in production, and the cost problem makes the mass production difficult. In contrast, when the root mean square roughness exceeds 16 nm, the kinematic viscosity of the base oil should be increased to keep the oil film parameter above a specific value and, depending on application, the required torque cannot be satisfied. Therefore, in the present invention, the root mean square roughness of the raceway surface of at least one of the inner ring 2 and the outer ring 3 is controlled to be in a range from 4 to 16 nm.

In addition, in the rolling bearing for the inverter-driven motor of the present invention, it is necessary that oil film parameter Λ in a steady operation condition be at least 17.5, and it is more preferable that it be at least 20. The greater this oil film parameter Λ, the greater is the suppression effect of electrolytic corrosion. However, it is not desirable that it be too large, since if bearing torque is too large, power consumption of the motor is increased.

Furthermore, grease 5 is supplied on contact surfaces between the inner ring 2 and the rolling element 4 and between the outer ring 3 and the rolling element 4, respectively. In the present invention, it is necessary that the kinematic viscosity at 40° C. of the base oil of the grease be at least 24 mm²/s. When the kinematic viscosity at 40° C. is less than 24 mm²/s, the service life of the bearing is shortened.

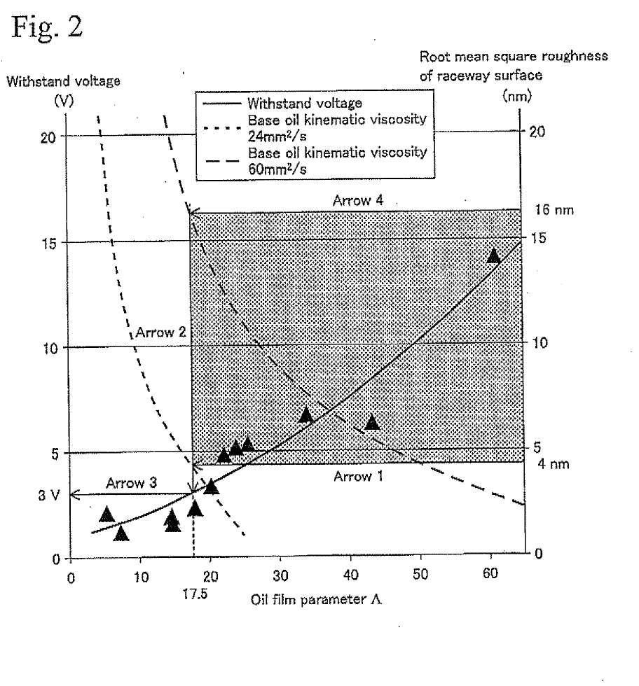

The inventors have conducted various research with respect to the oil film parameter Λ, the root mean square roughness of the raceway surface of the inner ring or the outer ring, and the withstand voltage, in the rolling bearing for inverter-driven motor of the present invention, and as a result, they have found each of the correlations shown in FIG. 2. FIG. 2 is a graph showing correlations of the withstand voltage and the root mean square roughness of the raceway surface to the oil film parameter Λ in the present invention. In FIG. 2, three curves are shown by a continuous line, a long-dashed line, and a short-dashed line.

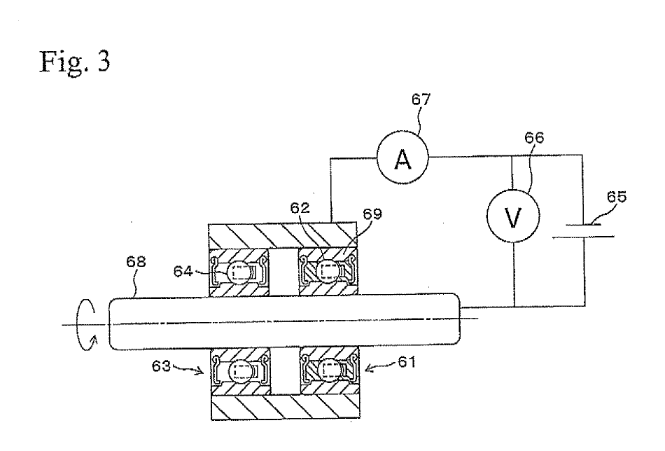

The continuous line is an approximate curve based on measured values of withstand voltage at 1000 rpm measured while changing the oil film parameter Λ in the rolling bearing for an inverter-driven motor, according to the following method, and it shows the correlation between the oil film parameter Λ and the withstand voltage. The withstand voltage is measured by a measuring apparatus which is schematically shown in FIG. 3. In this measuring apparatus, a 608ZZ ball bearing 61 (outer diameter: 22 mm, inner diameter: 8 mm, width: 7 mm) produced by Minebea Co., Ltd., which is supplied with a required amount of grease with metallic balls 62, is fixed on one end of a metallic shaft 68, an electric circuit is provided between the shaft 68 and the outer ring 69 by electrically connecting the shaft 68 and the variable voltage DC power supply 65 through a brush (not shown), and moreover, voltage and current between the shaft 68 and the outer ring 69 can be measured using the voltmeter 66 and the ammeter 67. In addition, the dummy ball bearing 63, in which the metallic balls 62 of the 608ZZ ball bearing 61 produced by Minebea Co., Ltd., are replaced with ceramic balls 64, is fixed at the other end of the shaft 68, so that current flows only through the ball bearing 61. In this measuring apparatus, withstand voltage of the ball bearing is measured while changing the oil film parameter value, and an approximate curve shown by the continuous line in FIG. 2 is obtained based on the measured values indicated by solid black triangles.

In addition, the short-dashed line and the long-dashed line show the relationship between the root mean square roughness of the raceway surface of the inner ring or the outer ring and the oil film parameter Λ, with respect to the base oils in which kinematic viscosities at 40° C. are 24 mm²/s and 60 mm²/s, respectively. This relationship can be calculated from Equation 1. Here, hmin value is a value that measures grease at a rotational speed of 1000 rpm by optical interferometry.

In the graph of FIG. 2 as obtained above, for example, when the root mean square roughness on the raceway surface of the inner ring or the outer ring is 4 nm and the kinematic viscosity of base oil is 24 mm²/s, the oil film parameter is proven to be 17.5 by going leftwards along the arrow 1 from the value of 4 nm on the right vertical axis until the short-dashed line, and going downwardly along the arrow 2 from the short-dashed until the horizontal axis. In addition, the withstand voltage of a rolling bearing when the oil film parameter is 17.5 is proven to be 3 V by going along the arrow 3 from the intersection of the arrow 2 and the continuous line until the left vertical axis. In the same manner, when the root mean square roughness on the raceway surface is 16 mm and the kinematic viscosity of base oil is 60 mm²/s, the oil film parameter is also 17.5, and therefore, the withstand voltage is also 3 V.

In applications of inverter-driven motors for household electrical appliances (fan motors for air conditioners, washing machine motors, cleaner motors, etc.), fan motors for office equipment, etc., since potential difference between the rolling element and the shaft is less than 3 V, it is necessary to increase the withstand voltage of the rolling bearing above the shaft voltage in order to prevent the electrolytic corrosion in the inverter-driven motor, that is, it is necessary that the withstand voltage of the bearing be at least 3 V. In other words, it is necessary that the oil film parameter of the rolling bearing be at least 17.5 in normal operation condition. In addition, the kinematic viscosity of the base oil may exceed 60 mm²/s if the bearing is used in an application in which bearing torque is irrelevant. Therefore, the range defined by the present invention is shown by a halftone dot meshing region (gray area) of FIG. 2.

In FIG. 2, the requirement of the withstand voltage of the rolling bearing of at least 3 V, that is, the oil film parameter of 17.5, is satisfied by the root mean square roughness of the raceway surface of 4 mm to the base oil kinematic viscosity of 24 mm²/s, and the root mean square roughness of the raceway surface of 16 nm to the base oil kinematic viscosity of 60 mm²/s. Supporting these two conditions, when the relationship between the base oil kinematic viscosity and the root mean square roughness of the raceway surface, in which the base oil kinematic viscosity is between 24 mm²/s and 60 mm²/s and the oil film parameter is 17.5, is approximated to a linear function, this can be expressed by Equation 2.

y=3x+12 (Equation 2)

In the equation, x is root mean square roughness of the raceway surface (unit: nm), and y is base oil kinematic viscosity (unit: mm²/s). Therefore, with respect to the range defined by the present invention, when the root mean square roughness of the raceway surface x is 4 nm≦x≦16 nm, the base oil kinematic viscosity y (mm²/s) is at least (3x+12), i.e., y≧(3x+12).

As described above, according to the rolling bearing for the inverter-driven motor of the present invention, it is proven that the withstand voltage at 1000 rpm of at least 3 V is obtained by setting the root mean square roughness of at least one of the inner ring and the outer ring of the raceway surface to be 4 to 16 nm and by setting the oil film parameter Λ to be at least 17.5. Thus, in the rolling bearing for the inverter-driven motor of the present invention, since very high withstand voltage at 1000 rpm of at least 3 V can be obtained, electrolytic corrosion due to discharge can be efficiently suppressed.

Furthermore, in the present invention, in the case in which the oil film parameter is fixed, the withstand voltage of the rolling bearing is improved by increasing the kinematic viscosity of grease base oil at 40° C., as shown in FIG. 2. However, when the kinematic viscosity is too great, bearing torque is increased and power consumption is adversely affected. Therefore, in applications of inverter-driven motors for household electrical appliances (fan motors for air conditioners, washing machine motors, cleaner motors, etc.), fan motors for office equipment, etc., it is desirable to limit the kinematic viscosity of the base oil of grease at 40° C. to 60 mm²/s or less. However, in applications in which there is no problem, even if the bearing torque is slightly great, it may exceed 60 mm²/s.

The rolling bearing in the present invention may be a roller bearing, a needle bearing, or an angular type ball bearing, in addition to the deep groove ball bearing, and it may be optionally selected as to size, shape, quantity, material, etc., depending on usage conditions or usage purpose of the inverter-driven motor, or the like motor. In addition, the grease in the present invention may be grease using lithium soap or urea as the thickener.

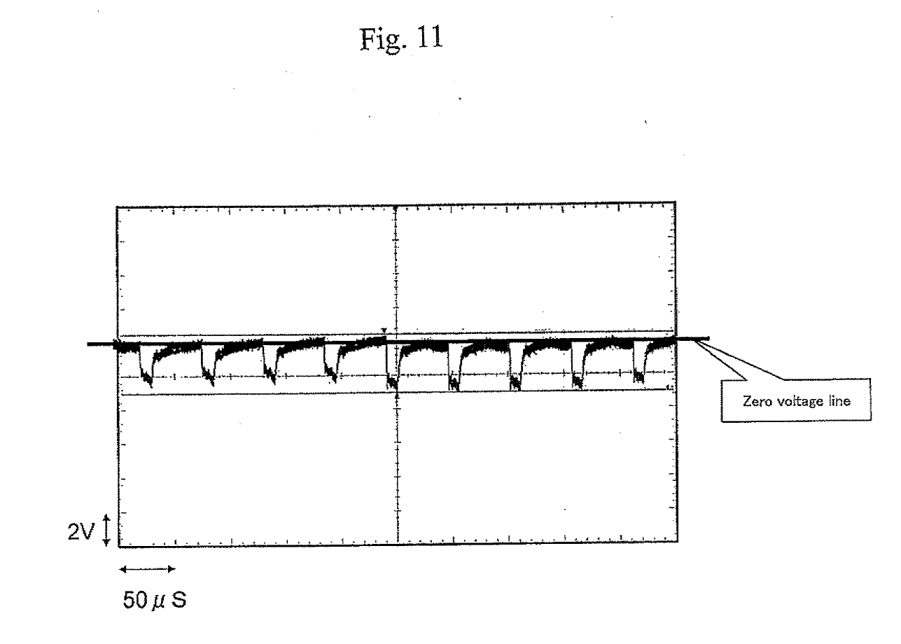

Next, an inverter-driven motor of the present invention using the above rolling bearing for the inverter-driven motor will be explained with reference to drawings. In the inverter-driven motor of the present invention, the shaft voltage can be reduced to be low, specifically, to be 3 V or less as shown in a measured result of FIG. 11, by a construction described below in detail. As a result, the electrolytic corrosion can be appropriately suppressed when the above described rolling bearing for the inverter-driven motor of the present invention is assembled therein.

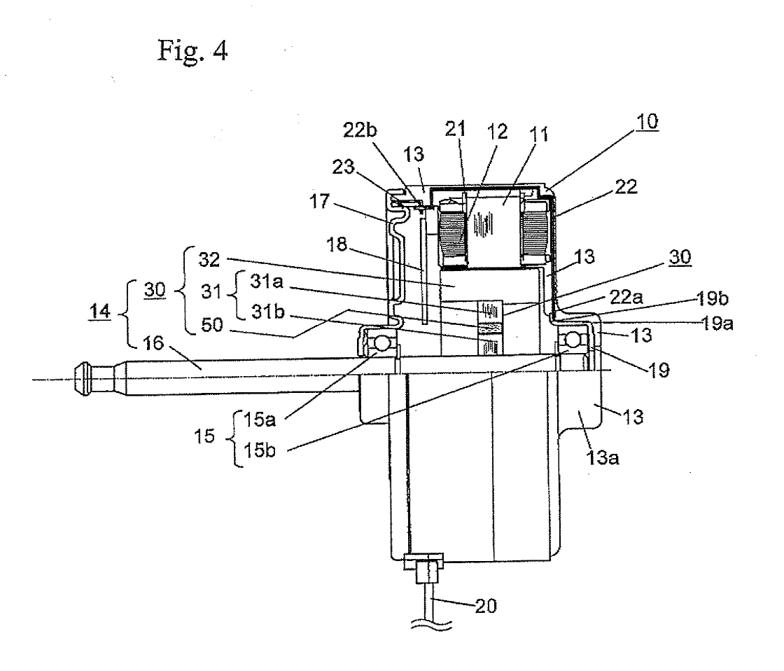

FIG. 4 is a schematic cross-sectional view showing an inner rotor type motor, which is an embodiment of the inverter-driven motor according to the present invention. In the present embodiment, one example of a motor, which is a brushless motor used in an air conditioner as home electric appliance, and which drives a blower fan, will be explained. In addition, in the present embodiment, another example of an inner rotor type motor in which the rotor is rotatably arranged at an inner circumference side of the stator, will be explained.

In FIG. 4, in a stator iron core 11, resin 21 is intervened as an insulator which isolates the stator iron core 11, and the stator windings 12 is wound. Such stator core 11 is molded with the insulating resin 13 used as a mold material together with other fixed members. In the present embodiment, the stator 10 having a substantially cylindrical outer shape is constructed by molding as one body these members as described above.

A rotor 14 is inserted in the stator 10 through a gap. The rotor 14 comprises a rotor 30 in a disc shape including a rotor iron core 31 and a shaft 16 which fastens the rotor 30 while passing through the center of the rotor 30. The rotor 30 holds a ferrite resin magnet 32 as a permanent magnet, facing an inner circumference side of the stator 10 in a circumferential direction. In addition, although the details will be explained below, the rotor 30 has a structure in which an outer iron core 31a which constitutes an outer circumference portion of the rotor iron core 31, a dielectric layer 50, and an inner iron core 31b which constitutes an inner circumference portion of the rotor iron core 31 are arranged in this order from the outermost ferrite resin magnet 32 to the shaft 16 at an inner circumference side, as shown in FIG. 4. FIG. 4 shows an example of the rotor 30 in which the rotor iron core 31, the dielectric layer 50 and the ferrite resin magnet 32 are molded as one body. In this way, they are arranged so that an inner circumference side of the stator 10 faces an outer circumference side of the rotor 30.

Two bearings 15 for supporting the shaft 16 are attached to the shaft 16 of the rotor 14. The bearings 15 are bearings in a cylindrical shape having a plurality of steel balls, and the inner ring sides of the bearings 15 are fixed to the shaft 16. In FIG. 4, the bearing 15a supports the shaft 16 at the output shaft side which is the side in which the shaft 16 protrudes from the brushless motor main body, and the bearing 15b supports the shaft 16 at the opposite side (hereinafter, referred to as a side opposite to output shaft side). Then, the outer ring sides of the bearings 15 are fixed respectively by a conductive metallic bracket. In FIG. 4, the bearing 15a at the output shaft side is fixed by the bracket 17, and the bearing 15b at the side opposite to output shaft side is fixed by the bracket 19. The shaft 16 is supported by the two bearings 15 according to the above configuration, and the rotor 14 can be freely rotated.

Furthermore, in this brushless motor, a printed circuit board 18 which packages a driving circuit including a control circuit is contained. A brushless motor is formed by press-fitting the bracket 17 in the stator 10 after this printed circuit board 18 is built-in. In addition, in the printed circuit board 18, interconnect lines 20 such as a lead wire, a ground line of a control circuit, etc., which applies source voltage of winding Vdc, source voltage of control circuit Vcc, and control voltage for controlling rotational frequency Vsp, are connected.

It should be noted that a zero potential point portion on the printed circuit board 18 in which the driving circuit is packaged is isolated from the grounded earth and primary (power source) circuit, and potential of the grounded earth and the primary power source circuit means a floating condition. Here, the zero potential point portion means a wiring having 0 volt potential as a standard potential on the printed circuit board 18, and shows a ground wiring generally called a “ground”. The ground line which is included in the interconnect lines 20 is connected with this zero potential point portion, that is, the ground wiring. In addition, a power source circuit which supplies source voltage of winding connected on the printed circuit board 18 in which the driving circuit is packaged, a power source circuit which supplies source voltage of the control circuit, a lead wire which applies the control voltage, a ground line of the control circuit, etc., are electrically isolated from all of a primary (power source) circuit for a power source circuit which supplies power source voltage of the wiring, a primary (power source) circuit for a power source circuit which supplies power source voltage of the control circuit, grounded earth connected with these primary (power source) circuits, and grounded earth independently grounded. That is, since the driving circuit packaged on the printed circuit board 18 is electrically isolated from the primary (power source) circuit potential and potential of the grounded earth, the potential is in a floating condition. This is expressed as a potential floating condition, and this is well known. In addition, from such facts, constructions of a power source circuit which supplies power source voltage of the winding connected with the printed circuit board 18, and a power source circuit which supplies power source voltage of the control circuit, are expressed as a floating power source, and this is also well known.

With respect to the brushless motor constructed as described above, each power source voltage and control signal is supplied through the interconnect line 20, and a stator winding 12 is driven by the driving circuit on the printed circuit board 18. When the stator winding 12 is driven, driving current flows in the stator winding 12, and magnetic field is generated from the stator iron core 11. Then, by magnetic field from the stator iron core 11 and magnetic field from the ferrite resin magnet 32, attractive force and repulsive force are generated depending on polarity of these magnetic fields, and the rotor 14 rotates around the center of the shaft 16 by these forces.

Next, the structure of the brushless motor according to the present invention will be explained in detail.

First in the brushless motor of the present invention, a shaft 16 is supported by two bearings 15, as described above, and each of the bearings is also fixed and supported by brackets. Furthermore, in the present embodiment, in order to prevent the problem clue to creep as described above, each bearing 15 has a structure fixed by metallic brackets having conductivity. That is, in the present embodiment, conductive brackets having high dimensional accuracy, which are produced by previously processed steel plates, are adopted for fixing the bearings 15. In particular, in the case in which increasing output power of the motor is required, it is preferable that such a structure be used.

Specifically, a bearing 15b at a side opposite to output shaft side is fixed by the bracket 19 having an outer diameter approximately equal to that of the bearing 15b. In addition, this bracket 19 is molded with insulating resin 13 as one body. That is, as shown in FIG. 4, the insulating resin 13 at a side opposite to output shaft side has a shape having a main body protruding portion 13a which protrudes from the present brushless motor main body toward a direction opposite to output shaft direction. The bracket 19 is arranged inside of this main body protuberance 13a as an inner bracket, and is molded with the insulating resin 13 as one body. The bracket 19 has a hollow cylindrical cup-like shape, and more specifically, it has a cylinder portion 19a in which one side is opened, and a ringed collar portion 19b which is slightly spread from a cylindrical edge portion at an opened side toward an outside direction. An inner diameter of the cylinder portion 19a is almost equal to an outer diameter of the bearing 15b, and by press-fitting the bearing 15b in the cylinder portion 19a, the bearing 15b is fixed to the insulating resin 13 also through the bracket 19. By constructing as described above, an outer ring side of the bearing 15b is fixed to the metallic bracket 19, and thereby the problem due to creep can be prevented. In addition, an outer diameter of the collar portion 19b is slightly greater than an outer diameter of the bearing 15b. That is, the outer diameter of the collar portion 19b is greater than the outer diameter of the bearing 15b and is less than at least an outer diameter of the rotor 30. According to the bracket 19 having such a shape, use of metallic materials that increase cost can be suppressed, in comparison with a structure in which for example, the collar portion exceeds a circumference of the rotor 30 and extends to a stator 10. Additionally, noise generated from the bearing 15b can also be prevented by reducing the area of the metallic bracket 19 as described above, and moreover, by molding as one body, so as to cover the outline of the bracket 19 with insulating resin 13.

Next, a bearing 15a at an output shaft side is fixed by a bracket 17 having an outer diameter almost equal to an outer diameter of the stator 10. The bracket 17 has nearly a disk-like shape, and comprises a protruding portion having a diameter almost equal to an outer diameter of the bearing 15a at the central area of the disk, and the inside of this protruding portion is hollow. The present brushless motor is formed by press-fitting the inside of the protruding portion of such bracket 17 in the bearing 15a after a printed circuit board 18 is built-in, and by press-fitting the bracket 17 in the stator 10, so as to fit a connecting end provided on a circumference of the bracket 17 and a connecting end of the stator 10. By constructing as described above, facilitation of the assembly process can be attempted, and the problem due to creep can also be prevented, since the outer ring side of the bearing 15a is fixed to the metallic bracket 17.

In addition, a conductive pin 22 is previously electrically connecting in the bracket 19. That is, one tip portion 22a of the conductive pin 22 is connected with the collar portion 19b of the bracket 19, as shown in FIG. 4. The conductive pin 22 is arranged inside of the insulating resin 13, and is molded with the insulating resin 13 as one body as well as the bracket 19. It should be noted that the conductive pin 22 is protected from rust, external forces, etc., by arranging it inside of the insulating resin 13 that is a motor inside, and thereby an electrical connection having high reliability in usage environments, external stresses, etc., is attained. The conductive pin 22 extends from the collar portion 19b toward an outer circumference direction of the present brushless motor, at inside of the insulating resin 13, and it further extends almost parallel to the shaft 16 from the vicinity of the outer circumference of the present brushless motor to the output shaft side. Then, the other tip portion 22b of the conductive pin 22 is exposed from an end surface at the output shaft side of the insulating resin 13. Furthermore, a conductive pin 23 is connected to the tip portion 22b in order to electrically connect the conductive pin 22 with the bracket 17. That is, when the bracket 17 is press-fitted in the stator 10, the conductive pin 23 contacts with the bracket 17, and conduction between the bracket 17 and the conductive pin 23 is ensured. By such a structure, the two brackets, the bracket 17 and the bracket 19, are electrically connected through the conductive pin 22. In addition, the bracket 17 and the bracket 19 are electrically connected in a condition isolated from a stator iron core 11 by the insulating resin 13.

Here, since an outer ring side of the bearing 15a is press-fitted in a protruded portion of the bracket 17, the outer ring of the bearing 15a and the bracket 17 are electrically connected, and in contrast, since an outer ring side of the bearing 15b is press-fitted in a cylindrical portion 19a of the bracket 19, the outer ring of the bearing 15b and the bracket 19 are electrically connected. Therefore, the outer ring of the bearing 15a and the outer ring of the bearing 15b are electrically connected by electrically connecting the bracket 17 and the bracket 19.

Then, in the present embodiment, in the rotor 30, a dielectric layer 50 is provided between the shaft 16 and the outer circumference of the rotor 30.

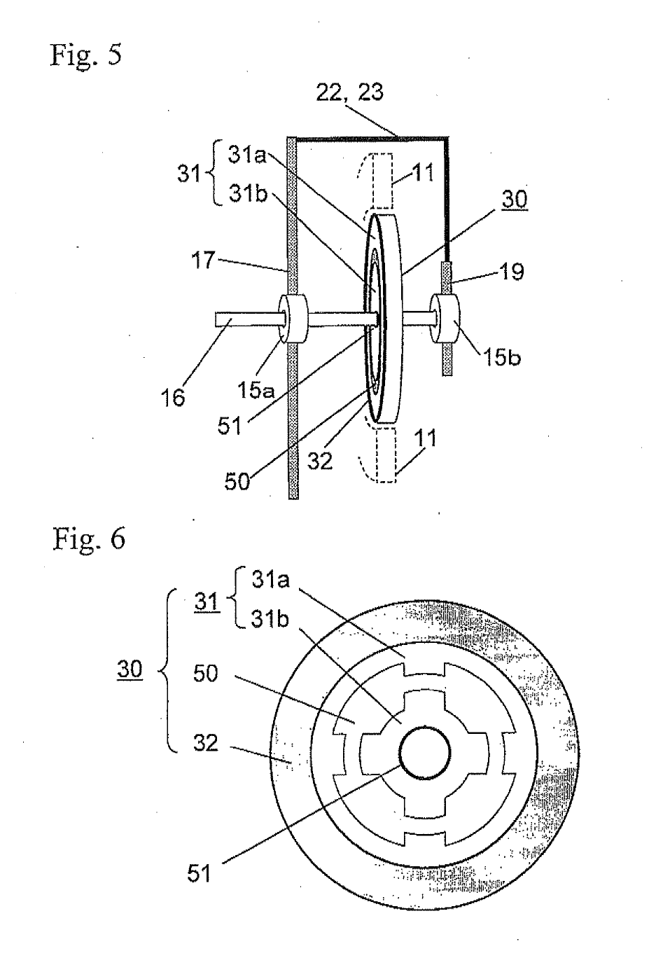

FIG. 5 is a schematic view showing a main section of the present brushless motor shown in FIG. 4. As shown in FIG. 5, the bracket 17 and the bracket 19 are electrically connected, but they are not connected with the stator iron core 11.

Here, in the case in which the bracket 17 is not connected with the bracket 19, impedance of the two brackets differs since the shape or configuration of the two brackets differs. Therefore, an imbalance is generated between potential induced in the bracket 17 and potential induced in the bracket 19. According to this imbalance of potential, there is a problem in that high-frequency current easily flows through the shaft 16 from the output shaft side to the side opposite to output shaft side or from the side opposite to output shaft side to the output shaft side.

In the present embodiment, by electrically connecting the bracket 17 and the bracket 19, the potentials of the two brackets are equalized and the imbalance of potentials are suppressed, and the high-frequency current hardly flows through the shaft 16.

In addition, in the case in which the conductive pin 22 for connecting the bracket 17 with the bracket 19 is also connected to the stator iron core 11, impedance at the stator side is decreased. When the impedance is reduced, the potential at the stator side, that is, at the outer ring side of the bearing, becomes in high condition, as described above. In contrast, in the present embodiment, by isolating the conductive pin 22 from the stator iron core 11, the reduction of the impedance is suppressed and the potential at the outer ring side of the bearing is held in low condition. In addition, impedances at a stator side and at a rotor side are easily balanced by the above effect, as explained below. Furthermore, in the present embodiment, the bracket 17 and the bracket 19 can be electrically connected while ensuring the isolation from the stator iron core 11, just by press-fitting the bracket 17 in the stator 10, as described above. Therefore, during a production process, potentials of both the brackets can easily be equalized while suppressing the reduction of the impedance at the stator side.

Next, as shown in FIG. 5, a ferrite resin magnet 32 is arranged at the outermost circumference of the rotor 30, and furthermore, an outer iron core 31a which forms a rotor iron core 31, a dielectric layer 50, and an inner iron core 31b which forms a rotor iron core 31 are arranged toward the inner circumference side, in this order. In addition, the dielectric layer 50 is a layer formed by insulating resin. In the present embodiment, such a dielectric layer 50 is provided in order to control electrolytic corrosion. FIG. 5 shows one example in which the dielectric layer 50 is formed in a ring shape arranged around the shaft 16 between the inner circumference side and the outer circumference side of a rotor 30. The rotor 30 has a construction which integrates the ferrite resin magnet 32, the outer iron core 31a, insulating resin for forming the dielectric layer 50, and the inner iron core 31b as one body, as described above. In addition, at a fastening portion 51 on the inner circumference of the inner iron core 31b, the rotor 30 is fastened on the shaft 16. Thereby, a rotor 14 supported by the bearing 15 is constructed.

In the rotor 30, the dielectric layer 50 is a layer formed by insulating resin as an insulator, and it isolates and separates the outer iron core 31a and the inner iron core 31b in series. At the same time, the dielectric layer 50 is formed by the insulating resin having a specific dielectric constant, and a high-frequency current can flow between the outer iron core 31a and the inner iron core 31b.

Additionally, in the case in which such a dielectric layer 50 is not provided, impedance between the brackets considering the stator iron core as reference is high, and in contrast, impedance between the shaft ends that electrically connect with the rotor is low, as described above. High-frequency current having pulse width modulation generated by the stator iron core, etc., flows in an equivalent circuit having such impedance components. Therefore, potential due to the high-frequency current is generated between the outer ring of the bearing electrically connected with the bracket and the shaft at an inner ring side of the bearing.

In the present embodiment, impedance of the rotor 14 is increased by providing a dielectric layer 50 as shown in FIG. 5 in a rotor having low impedance, so as to approximate to the impedance of the bracket side. That is, by providing the dielectric layer 50 between the outer iron core 31a and the inner iron core 31b, the rotor 14 has a construction in which static capacitance generated by the dielectric layer 50 is equivalently connected in series, and the impedance of the rotor 14 can be increased. Then, voltage drop having high frequency which flows from the rotor 14 to the shaft 16 is increased by increasing the impedance of the rotor 14, and whereby potential generated on the shaft 16 by the high-frequency current can be decreased. In the brushless motor of the present embodiment, potential difference due to high-frequency current is reduced between the outer ring of bearing 15 electrically connected with the brackets 17 and 19 and the shaft 16 at the inner ring side of the bearing 15, based on such a principle. It should be noted that, in the present embodiment, reduction of impedance of the brackets 17 and 19 is suppressed by isolating the brackets 17 and 19 from the stator iron core 11, as described above, and impedances of the brackets 17 and 19 are also increased. Therefore, potential is always low between the bearing inner ring and the bearing outer ring, and the potential difference is balanced to be lower, and as a result, generation of electrolytic corrosion of the bearing is suppressed.

Furthermore, in the present embodiment, by electrically connecting between the bracket 17 and the bracket 19 through a conducting pin 22, potentials of both brackets are equalized, and flow of high-frequency current through the shaft can be suppressed. In addition, potential difference between the inner ring and the outer ring of the bearing 15a can be approximate or can be equalized to potential difference between the inner ring and the outer ring of the bearings 15b by equalizing the potentials of the two brackets. In such a structure, with respect to the bearing 15a and the bearing 15b, respectively, the potential difference between the inner ring and the outer ring of the bearings, that is, shaft voltage, can be lowered by appropriately adjusting the impedance at a rotor side using the dielectric layer 50. Therefore, a problem in which electrolytic corrosion can be suppressed in one bearing, but the electrolytic corrosion is generated in the other bearing, can be prevented. Thus, with respect to two bearings fixed by conductive brackets, respectively, the potential difference between the inner ring and the outer ring of the bearings can be maintained to be low, and therefore, the electrolytic corrosion of the bearing generated by high frequency caused by PWM or the like can be prevented, while fixing strength of the bearings is ensured.

In addition, since the static capacitance can be changed by changing width and material of the dielectric layer 50, impedance at the rotor 14 side can also be optimized. That is, the static capacitance generated by the dielectric layer 50 can be lowered by decreasing the dielectric constant of the insulating resin for forming the dielectric layer 50, by increasing thickness of the insulating resin (distance between electrodes), by decreasing surface area of electrodes, or the like. Thus, the impedance of the rotor 14 can be increased by decreasing the static capacitance generated by the dielectric layer 50.

Additionally, a low-dielectric constant can be attained by using syndiotactic polystyrene (hereinafter referred to as SPS) resin as an insulating resin for forming the dielectric layer 50, and impedance of the rotor 14 can be increased, even when the thickness of the insulating resin is small. That is, as resin usually used for the insulating resin of the motor, polybutylene terephthalate (hereinafter referred to as PBT) resin, polyethylene terephthalate (hereinafter referred to as PET) resin, etc., reinforced by an inorganic filler such as glass fiber, etc., can be mentioned, and the dielectric constants of these materials are about 3.5. In contrast, the dielectric constant is 2.6 for non-reinforced SPS resin and 2.8 for reinforced SPS resin, which means that the dielectric constants of the SPS are lower than those of usual resins. Therefore, when the upper limit of thickness of the insulating resin is structurally limited and the impedance of PBT resin or the like is low and insufficient, the static capacitance can be decreased by using the SPS resin.

Furthermore, the rotor 30 is constructed so that an outer iron core 31a and an inner iron core 31b are separated by the dielectric layer 50, as shown in FIG. 5, and as a result, the rotor iron core and insulating resin can be molded as one body in condition in which the shaft 16 is not present in the production process. Therefore, in comparison with the structure in which the dielectric layer is provided between the shaft and the rotor iron core, the structure shown in FIG. 5 can mold the rotor 30 in a condition without the shaft and can increase productivity. In addition, according to the structure shown in FIG. 5, even if the design of the shaft 16 is changed, the shaft 16 can be fixed by calking or press-fitting, and therefore, a design change of the shaft can be easily accepted and the productivity can also be improved by this effect.

FIG. 6 is a schematic view showing a specific example of a rotor of a brushless motor in a first embodiment of the present invention, FIG. 6 shows the specific example of the rotor observed from the side. The rotor shown in FIG. 6 comprises a dielectric layer 50 in a shape which combines circular arcs of several types in which radial widths thereof differ between an outer iron core 31a and an inner iron core 31b in a radial direction. That is, the dielectric layer 50 has a shape in which convex protruding shapes and concave protruding shapes are repeatedly arranged on at least one side of an outer circumference side and an inner circumference side. In addition, the outer iron core 31a and the inner iron core 31b are fit with the dielectric layer 50 having such a shape.

In the case in which the dielectric layer 50 is formed to be a perfect ring shape as shown in FIG. 5, there are problems such as slipping during rotating, etc. In contrast, in the case in which the dielectric layer 50 is formed in a shape as shown in FIG. 6, the slipping can be prevented, and moreover, rotational strength can be increased by inserting the protruding shapes for preventing the slipping between the dielectric layer 50 and the iron core. Specifically, the protruding shapes for preventing slipping are provided on the outer iron core 31a and the inner iron core 31b, respectively, so that the protruding shapes face each other.

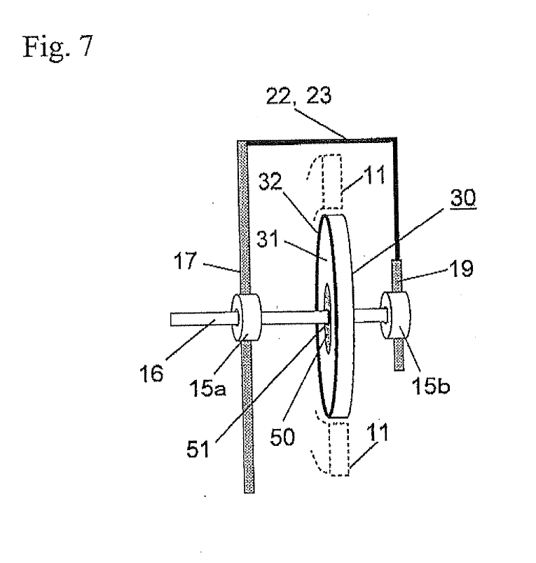

FIG. 7 is a schematic view showing another specific example of a rotor of a brushless motor in a first embodiment of the present invention. In a rotor 30 shown in FIG. 7, a ferrite resin magnet 32 is arranged on the outermost circumference, and in addition, a rotor iron core 31 and insulating resin forming a dielectric layer 50 are arranged, in this order, toward the inside. Thus, the rotor 30 shown in FIG. 7 has a structure in which the ferrite resin magnet 32, the rotor iron core 31, and the insulating resin forming the dielectric layer 50 are formed as one body. In addition, the rotor 30 is fastened to a shaft 16 at a fastening portion 51 on an inner circumference of the dielectric layer 50. That is, the rotor 30 is fastened to the shaft 16 through the dielectric layer 50. The rotor 14 may have such structure, and a static capacitance generated by the dielectric layer 50 is connected in series between the rotor iron core 31 and the shaft 16, and consequently, impedance of the rotor 14 can be increased.

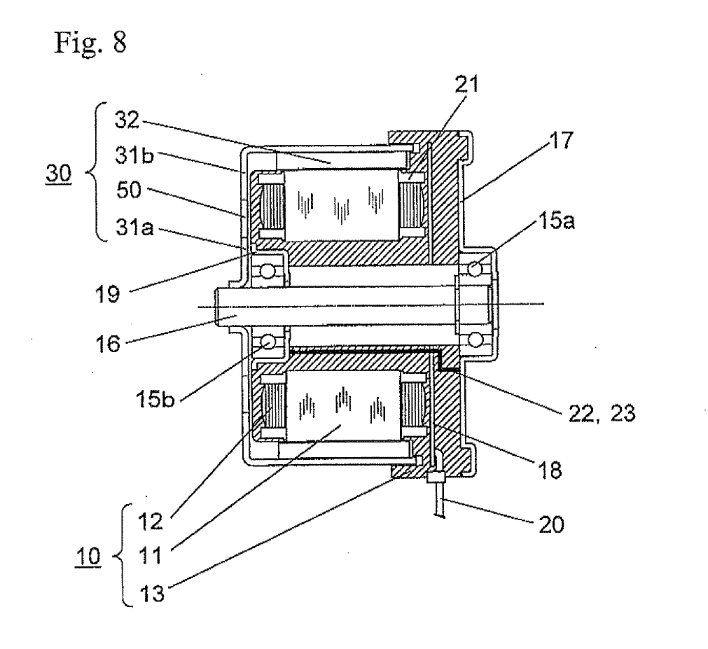

Next, an outer rotor type motor in which a rotor is arranged on a circumference side of a stator will be explained. FIG. 8 is a structural view showing a cross section of an outer rotor type motor as another specific example of the present embodiment. It should be noted that in FIG. 8, the components corresponding to those in FIG. 4 are denoted with the same reference symbols. In FIG. 8, a stator 10 is constructed by molding a stator iron core 11 wound by a stator winding 12 with insulating resin 13. Furthermore, a bracket 17 and a bracket 19 are molded as one body in the stator 10, and bearings 15a are fixed in the bracket 17, and bearings 15b are fixed in the bracket 19. A shaft 16 is inserted to the inner rings of the bearings 15a and the bearings 15b, and a rotor 30 in a hollow cylindrical shape is fictened at one end of the shaft 16. In addition, the stator iron core 11 is arranged at an inside hollow portion of the rotor 30. Additionally, in the rotor 30, a ringed dielectric layer 50 is provided so as to sandwich between an outer iron core 31a and an inner iron core 31b. Furthermore, the bearings 15a and the bearings 15b are electrically connected by a conducting pin 22, etc. In such an outer rotor type motor, the same effect can also be attained by providing a dielectric layer 50 as shown in FIG. 8 as well as the structure shown in FIG. 4, and by electrically connecting the bracket 17 and the bracket 19.

### EXAMPLES

1. Rolling Bearing for Inverter-Driven Motor

### Example 1

As shown in Table 1, grease having a kinematic viscosity at 40° C. of 55 nm²/s and comprising ester oil as a base oil and lithium soap as a thickener, was used. This grease was supplied at a required amount in a ball bearing (trade name: 608ZZ, produced by Minebea Co., Ltd., outer diameter: 22 mm, inner diameter: 8 mm, width: 7 mm) in which the root mean square roughness on the raceway surface of the inner ring was 8 nm. By this way, a rolling bearing for an inverter-driven motor of Example 1 according to the present invention having an oil film parameter Λ of 26 at 1000 rpm was produced.

TABLE 1

| | | | | 40° C. base | | |
|---|---|---|---|---|---|---|
| | | | Raceway | oil | Withstand | |
| | Voltage | | surface | kinematic | voltage of | |
| | maximum | Oil film | roughness | viscosity | bearing | |
| Test | value (V) | parameter Λ | (nm) | (mm²/s) | (V) | Evaluation |
| Example 1 | 3 | 26 | 8 | 55 | 5.3 | No |
| | | | | | | electrolytic |
| | | | | | | corrosion |
| Comparative | 10 | 16 | 14 | 55 | 2.3 | Electrolytic |
| Example 1 | | | | | | corrosion |
| Comparative | 3 | 14 | 8 | 26 | 1.9 | Electrolytic |
| Example 2 | | | | | | corrosion |

### Comparative Example 1

As shown in Table 1, grease having a kinematic viscosity at 40° C. of 55 mm²/s and comprising ester oil as a base oil and lithium soap as a thickener, was used. This grease was supplied at a required amount in a ball bearing (trade name: 608ZZ, produced by Minebea Co., Ltd., outer diameter: 22 mm, inner diameter: mm, width: 7 mm) in which the root mean square roughness on the raceway surface of the inner ring was 14 nm. By this way, a rolling bearing for an inverter-driven motor of Comparative Example 1 according to the present invention having an oil film parameter Λ of 16 at 1000 rpm was produced.

### Comparative Example 2

As shown in Table 1, grease having a kinematic viscosity at 40° C. of 26 mm²/s and comprising ester oil as a base oil and lithium soap as a thickener, was used. This grease was supplied at a require amount in a ball bearing (trade name: 608ZZ, produced by Minebea Co., Ltd., outer diameter: 22 mm, inner diameter: 8 mm, width: 7 mm) in which the root mean square roughness on the raceway surface of the inner ring was 8 nm. By this way, a rolling bearing for an inverter-driven motor of Comparative Example 2 according to the present invention having an oil film parameter Λ of 14 at 1000 rpm was produced.

With respect to the rolling bearings for inverter-driven motor of Example 1 and Comparative Examples 1 and 2 produced as described above, measurement of withstand voltage and electrolytic corrosion reproduction tests were carried out by the following method.

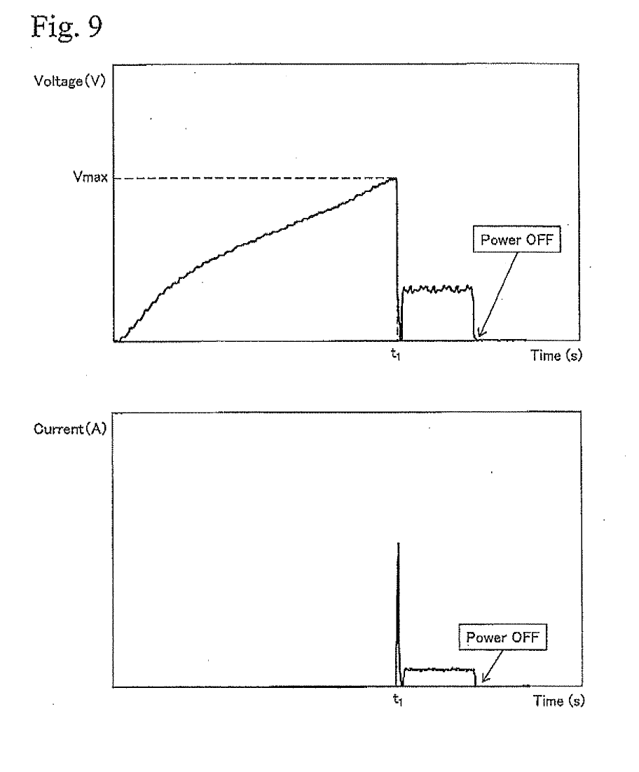

The withstand voltage was measured by a measuring device in which each rolling bearing for inverter-driven motor of Example 1 and Comparative Examples 1 and 2 was fixed to a metallic shaft, an electric circuit as schematically shown in FIG. 3 was provided between a shaft 68 and an outer ring 69, and the shaft 68 was electrically connected with a variable voltage DC power supply 65 by a brush (not shown). Then, in this measuring device, power supply voltage was gradually raised while rotating the shaft at a rotational speed of 1000 rpm, and voltage value and current value were measured. Graphs of the measured voltage value and current value are shown in FIG. 9.

Considering these graphs in detail, since an insulation condition is maintained by an oil film, the current did not flow at low voltage and the current value was zero. However, when the voltage was gradually increased, it suddenly dropped at certain time t1. At this time t1, thickness of the oil film was insufficient for maintaining the insulation condition at the increased voltage, and the current began to flow, and therefore, the current value rose. When the voltage was maintained in this condition, the current value was also maintained at almost a constant value, and thus, the graph became substantially horizontal after t1, as shown in FIG. 9. The maximum voltage value Vmax at this time was considered to be the withstand voltage value, and this value is shown in Table 1. It should be noted that the final drop to zero in the graph occurred because the power was turned off.

As is apparent from Table 1, it was shown that the withstand voltage of 5.3 V could be obtained in the rolling bearing for the inverter-driven motor of Example 1 in which the root mean square roughness on the raceway surface of the inner ring and the oil film parameter Λ were in the range defined by the present invention. In contrast, in the rolling bearings for the inverter-driven motor of Comparative Examples 1 and 2 in which the oil film parameter Λ was less than 17.5, it was shown that the withstand voltages were 2.3 and 1.9 V, respectively, and were less than the withstand voltage of 3 V which is required for inverter-driven motors in household electrical appliance application.

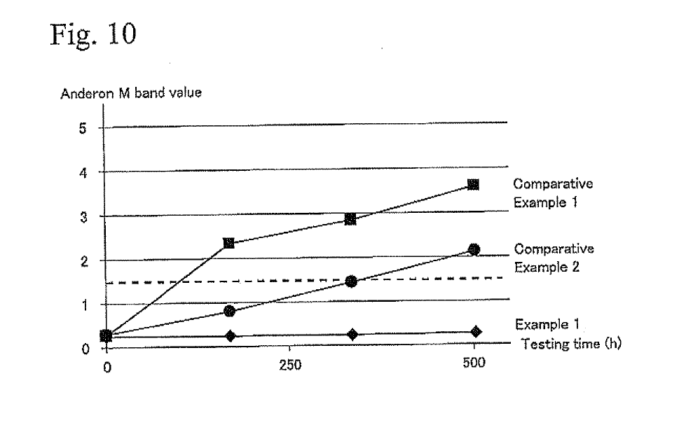

Next, the electrolytic corrosion reproduction test was carried out by continuous operation for a total of 504 hours at a rotational speed of 1000 rpm under acceleration test conditions in which high frequency rectangle pulse voltage having a maximum voltage of 3 V and frequency of 1.2 MHz was applied between the shaft and the outer ring, using the above measuring device in which the rolling bearings for the inverter-driven motor of Example 1 and Comparative Examples 1 and 2 were fixed to the shaft. For each of the Example and the Comparative Examples, four ball bearings were tested. The Anderon Medium band (M band) value was measured at the start of test and at every 168 hours (24 hours times 7 days is 168 hours). The average values of these measured values are shown in the graph of FIG. 10. It should be noted that since the Anderon values corresponding to the Anderon M band has high correlation with the vibration due to defect of shape or the like on a raceway surface of a bearing ring of a rolling bearing or on a rolling contact surface of a rolling element, in the present application, the Anderon M band value was used as an evaluation criterion for indicating the deterioration of roughness in the above surfaces caused by electrolytic corrosion. It was judged that electrolytic corrosion had occurred when the Anderon M band value was 1.5 or more,

As is apparent from FIG. 10, with respect to the rolling bearing for the inverter-driven motor of Example 1, the Anderon value after being tested for 504 hours hardly changed in comparison with the Anderon value at the start of the test. In contrast, with respect to the rolling bearing for the inverter-driven motor of Comparative Example 1, the Anderon value exceeded 1.5 after being tested for only 168 hours. In addition, with respect to the rolling bearing for the inverter-driven motor of Comparative Example 2, the Anderon value reached nearly 1.5 after 336 hours of test and exceeded 1.5 after 504 hours of test. Therefore, it was confirmed that in Example 1 where the voltage between the shaft and the outer ring was lower than the withstand voltage, electrolytic corrosion was not generated, whereas in Comparative Examples 1 and 2 where the voltage between the shaft and the outer ring was higher than the withstand voltage, electrolytic corrosion was generated.

2. Inverter-Driven Motor

A brushless motor having a structure shown in FIG. 4 was produced as an inverter-driven motor of the present invention by using the above rolling bearing for inverter-driven motor of the present invention, and a rotor having a structure shown in FIG. 6, in which PBT resin having a dielectric constant of 3.6 was used in the dielectric layer with the resin thickness of 2.5 mm at the minimum portion.

With respect to this brushless motor, the shaft voltage was measured using a direct current stabilized power supply, under a specific operating condition in which power supply voltage of winding Vdc was 391 V, power supply voltage of control circuit Vcc was 15 V, and rotational speed was 1000 rpm. It should be noted that the rotational speed was adjusted by control voltage Vsp and the brushless motor in the operation was arranged to have the shaft in a horizontal position.

The shaft voltage was measured by the following method: voltage waveform was observed using a digital oscilloscope (DPO7104 model, produced by Tektronix, Inc.) and a high voltage differential probe (P5205 model, produced by Tektronix, Inc.) to check the deformation of the waveform, and peak-to-peak voltage was measured as shaft voltage. This measured result of the shaft voltage is shown in FIG. 11. It should be noted that the time scale on the horizontal axis during measuring was set to be 50 μs/div.

As shown in FIG. 11, the shaft voltage in the inverter-driven motor of the present invention was held very low at 3 V or less and, as the waveform of the shaft voltage was not deformed, it was shown that discharge was prevented and electrolytic corrosion was suppressed.

What is claimed is:

1. A rolling bearing for an inverter-driven motor, comprising an inner ring, an outer ring, a rolling element, and grease,
wherein a root mean square roughness on an raceway surface of at least one of the inner ring and the outer ring is 4 to 16 nm, and an oil film parameter Λ in a steady operation condition is at least 17.5.

2. A rolling bearing for an inverter-driven motor, comprising an inner ring, an outer ring, a rolling element, and grease,
wherein a root mean square roughness on an raceway surface of at least one of the inner ring and the outer ring is 4 to 16 nm, and when the root mean square roughness of the raceway surface is set to be x in units of nm, and kinematic viscosity at 40° C. of base oil of the grease is set to be y in units of mm²/s, the equation y≧(3x+12) is satisfied.

3. The rolling bearing for an inverter-driven motor according to claim 1, wherein kinematic viscosity at 40° C. of base oil of the grease is at least 24 mm²/s.

4. The rolling bearing for an inverter-driven motor according to claim 1, wherein kinematic viscosity at 40° C. of base oil of the grease is at least 60 mm²/s.

5. The rolling bearing for an inverter-driven motor according to claim 1 wherein withstand voltage at 1000 rpm is at least 3 V.

6. The rolling bearing for an inverter-driven motor according to claim 1, wherein the rolling element is a ball, and the rolling bearing is a ball bearing having all of the outer ring, the inner ring, and the ball made by metal.

7. The rolling bearing for an inverter-driven motor according to claim 6, wherein the ball bearing is a deep groove ball bearing.

8. The rolling bearing for an inverter-driven motor according to claim 6, wherein the grease comprises an ester oil having kinematic viscosity at 40° C. of 24 to 60 mm²/s as a base oil, and a lithium soap as a thickener,

9. The rolling bearing for an inverter-driven motor according to claim 6, wherein an Anderon M band value after rotating the inner ring at a rotational speed of 1000 rpm for a total of 504 hours, while applying high frequency rectangle pulse voltage having a maximum voltage of 3 V and a frequency of 1.2 MHz between the inner ring and the outer ring, is less than 1.5.

10. An inverter-driven motor, wherein a motor shaft is supported by the rolling bearing for the inverter-driven motor according to claim 1.

11. The inverter-driven motor according to claim 10, wherein the motor shaft is supported by a pair of the rolling bearings for the inverter-driven motor separately attached to the motor axis in an axis direction.

12. The inverter-driven motor according to claim 11, wherein the outer rings of the pair of the rolling bearings for the inverter-driven motor are electrically connected to each other.

13. The inverter-driven motor according to claim 12, further comprising a rotor in a disc shape in which the motor shaft passes through the center thereof, a permanent magnet at an outmost edge of the rotor, and a dielectric layer consisting of a rotor iron core and insulating resin at an inner circumference side of the permanent magnet.

14. The inverter-driven motor according to claim 13, wherein the rotor comprises an outer iron core which form an outer circumference portion of the rotor iron core, an inner iron core which forms an inner circumference portion of the rotor iron core, and the dielectric layer held between the outer iron core and the inner iron core.

15. The inverter-driven motor according to claim 13, wherein the rotor iron core and the dielectric layer are arranged from an outer circumference side to an inner circumference side of the rotor in this order.

16. The inverter-driven motor, wherein a motor shaft is supported by a pair of rolling bearings for the inverter-driven motor according to claim 2 separately attached to the motor axis in an axis direction.

17. The inverter-driven motor according to claim 16, wherein outer rings of the pair of the rolling bearings for the inverter-driven motor are electrically connected to each other.

18. The inverter-driven motor according to claim 17, further comprising a rotor in a disc shape in which the motor shaft passes through the center thereof, a permanent magnet at an outmost edge of the rotor, and a dielectric layer consisting of a rotor iron core and insulating resin at an inner circumference side of the permanent magnet.

19. The inverter-driven motor according to claim 18, wherein the rotor comprises an outer iron core which forms an outer circumference portion of the rotor iron core, an inner iron core which forms an inner circumference portion of the rotor iron core, and the dielectric layer is held between the outer iron core and the inner iron core.

20. The inverter-driven motor according to claim 18, wherein the rotor iron core and the dielectric layer are arranged from an outer circumference side to an inner circumference side of the rotor in this order.
